(19) United States
(12) Patent Application Publication
(10) Pub. No.: US 2021/0278109 A1
(43) Pub. Date: Sep. 9, 2021

(54) Coolers Including Movable Thermoelectric Coolers and Related Methods

(71) Applicants: Arjun Menta, Plano, TX (US); Uksang Yoo, Austin, TX (US)

(72) Inventors: Arjun Menta, Plano, TX (US); Uksang Yoo, Austin, TX (US)

(21) Appl. No.: 17/191,349

(22) Filed: Mar. 3, 2021

Related U.S. Application Data
(60) Provisional application No. 62/984,446, filed on Mar. 3, 2020.

(51) Int. Cl. F25B 21/02; F25D 11/00; F25D 23/00; A61J 1/16

(52) U.S. Cl. CPC F25B 21/02; F25D 11/00; F25D 23/006; A61J 1/165; F25D 2201/12; A61J 2200/72; F25D 2700/121; F25B 2321/021; F25B 2321/023; A61J 2200/44; F25D 2600/04

(57) ABSTRACT

A cooler can comprise a shell that defines a cavity, a container disposed in the cavity, and one or more thermoelectric coolers (TECs). Each of the TEC(s) can have opposing first and second surfaces and be configured to transfer heat from the first surface to the second surface when an electric current flows through the TEC. Each of the TEC(s) can also be movable between a first position in which the first surface does not contact the container and a second position in which the first surface contacts the container.

### CROSS-REFERENCE TO RELATED APPLICATION

This Application claims priority to U.S. Provisional Patent Application No. 62/984,446, filed Mar. 3, 2020, which is incorporated herein by reference in its entirety.

### TECHNICAL FIELD

The present invention relates generally to coolers, and more particularly but without limitation to coolers that incorporate one or more thermoelectric coolers (e.g., one or more Peltier devices) to provide active cooling.

### BACKGROUND

Coolers are designed to maintain the temperature of items contained therein below that of the outside environment. They are used to transport a wide variety of items, such as food, beverages, medications, organs, blood, vaccines, and/or the like. Refrigeration of such items may be necessary to prevent degradation thereof during transport. For example, a vaccine may become ineffective if exposed to heat over a prolonged period of time, such as if the temperature of the vaccine is not maintained below 8° C. Additionally, consumable items such as food and beverages may be more enjoyable when their temperature is below ambient temperature.

To refrigerate the cooler's interior and thus the items therein, a cooling material such as ice is usually placed in the interior with the items. Over time the temperature of the cooler's interior may rise to ambient temperature as heat is transferred to the interior from the environment. A cooler typically includes an insulating shell to mitigate such heat transfer such that a desired level of refrigeration can be maintained over a longer period of time. The duration of refrigeration can also be extended by increasing the amount of cooling material in the cooler's interior; the more cooling material therein, the more heat that can be absorbed before the temperature of the cooler's interior rises above a desired level. Regardless, unless additional cooling material is added to the cooler's interior, the temperature therein eventually will rise to ambient temperature.

Such conventional cooler designs may face challenges, particularly when the refrigerated items need to be transported over large distances. For example, the amount of cooling material required to maintain adequate refrigeration for long transit times can significantly increase the weight of the cooler and decrease the cooler's available capacity for transported items. This weight increase may render transport difficult or infeasible, such as when the cooler must be transported by foot. As an example, many vaccine carriers can weigh over 60 pounds when loaded with an amount of cooling material required to maintain refrigeration in transit. And in many instances the cooler may not be able to hold an adequate amount of cooling material to prevent degradation of the transported items. Because additional cooling material may not be readily available in transit, this can lead to waste.

The use of a frozen cooling material such as ice may also pose issues. For example, items such as vaccines may be better preserved when the temperature in the cooler's interior is controlled and maintained within a particular range (e.g., between 2 and 8° C., for at least some vaccines) and may be damaged if they contact a frozen cooling material. Passive refrigeration does not provide such temperature control, and while some cooler designs include insulation disposed between transported items and the cooling material to prevent damage, the additional insulation reduces the cooler's carrying capacity.

Because of these drawbacks, conventional coolers often provide inadequate refrigeration that can yield significant in-transit losses. To illustrate, about 40% of vaccine doses worldwide are wasted annually in transit (amounting to about $11.76 billion in losses), due at least in part to the shortcomings of conventional vaccine carriers that may not provide suitable refrigeration for transport over large distances in rural areas. As a result, many individuals worldwide have limited access to vaccines; for example, vaccines are not being delivered to about 20% of children born worldwide.

### SUMMARY

Accordingly, there is a need in the art for mobile coolers that can maintain refrigeration for long periods of time and provide precise temperature control. The present coolers address this need in the art with a cooling system comprising one or more thermoelectric coolers (“TEC”), each configured to transfer heat from a first surface of the TEC to an opposing second surface thereof when an electric current flows through the TEC. The cooler can include a shell defining a cavity and a container disposed in the cavity, the container configured to receive one or more items for transport (e.g., one or more vaccine vials). Each of the TEC(s) can be movable from a first position in which the first surface does not contact the container to a second position in which the first surface contacts the container. To cool the container and thus the item(s) therein, the TEC(s) can be moved to the second position and powered such that they transfer heat away from the container. The second surface of each of the TEC(s) can be fixed to a heat sink disposed in an opening defined through the shell such that the heat absorbed by the TEC can be dispersed to the environment.

The TEC(s) need not be powered continuously to maintain a desired refrigeration temperature in the cavity (e.g., a temperature in the container); they can be controlled such that the TEC(s) are repeatedly activated and deactivated based on cooling requirements. Because heat is transferred from a TEC's first surface to its second surface when activated, the temperature of the second surface may be higher than that of its first surface. As a result, residual heat may be transferred back to the TEC's first surface when the TEC is deactivated. To mitigate heat transfer back to the container during periods in which the TEC is deactivated, the TEC can be returned to the first position such that it no longer contacts the container and thus does not conduct heat thereto. This operation can significantly reduce the energy required to maintain a suitable refrigeration temperature with the TEC(s).

By using such an efficient cooling system with compact TEC(s), the cooler can refrigerate transported items for long durations of time without large quantities of cooling material and thus can be lightweight and have a relatively small form factor. Additionally, because the TEC(s) operate using electricity, the cooler can include an electric power source (e.g., one or more batteries) that can be readily replaced with another power source in transit to extend refrigeration times, a feature not available in conventional coolers that rely on perishable cooling material for refrigeration (e.g., because additional cooling material is not transportable like a battery). The cooler can be configured to maintain a cavity temperature that is between 2 and 8° C. for at least 15-30 hours (e.g., when the temperature of the ambient environment around the cooler is 25° C. or higher), rendering it suitable to transport a number of items such as vaccines over large distances. Some of the present coolers comprise a shell that defines a cavity and a container disposed in the cavity. The container, in some coolers, defines one or more receptacles. Each of the receptacle(s), in some coolers, is configured to receive one or more vials. Some coolers comprise one or more, optionally two or more, thermoelectric coolers (TECs). Each of the TEC(s), in some coolers, have opposing first and second surfaces and are configured to transfer heat from the first surface to the second surface when an electric current flows through the TEC. In some coolers, each of the TEC(s) is movable between a first position in which the first surface does not contact the container and a second position in which the first surface contacts the container.

Some of the present cooling systems comprise one or more TECs, each having opposing first and second surfaces and configured to transfer heat from the first surface to the second surface when an electric current flows through the TEC. Some cooling systems comprise one or more actuators. In some cooling systems, the TEC(s) and actuator(s) are configured to be coupled to a cooler including a shell that defines a cavity and a container disposed in the cavity such that each of the TEC(s) is movable between a first position in which the first surface does not contact the container and a second position in which the first surface contacts the container and each of the actuator(s) configured to move at least one of the TEC(s) between the first and second positions.

Some of the present methods comprise disposing one or more items in one or more receptacles of a container. In some methods, the container is disposed in a cavity defined by a shell of a cooler when the item(s) are disposed in the receptacle(s). In some methods, the container is placed in the cavity after the item(s) are disposed in the receptacle(s). The one or more items, in some embodiments, comprise one or more vials that, optionally, each contains a vaccine. Some methods comprise moving each of one or more, optionally two or more, TECs of the cooler between a first position in which a first surface of the TEC does not contact the container and a second position in which the first surface contacts the container. Some methods comprise directing an electric current through each of the TEC(s), optionally from an electric power source, such that heat is transferred from a first surface of the TEC to an opposing second surface of the TEC when the first surface is in contact with the container. Some methods comprise, for each of the TEC(s), stopping electric current flow through the TEC and moving the TEC to the second position, optionally after the first surface of the TEC has contacted the container and the electric current has been directed through the TEC at least once.

In some embodiments, the shell has a width and a length, measured perpendicularly to the width, that each is between 4 and 8 inches. A height of the shell, measured perpendicularly to the width and length, is between 16 and 32 inches in some embodiments.

In some embodiments, by weight and/or volume, at least a majority of the container is a first material and/or at least a majority of the shell is a second material having a thermal conductivity that is less than or equal to 90% of the thermal conductivity of the first material. The thermal conductivity of the first material, in some embodiments, is greater than or equal to 100 W/m·K. The thermal conductivity of the second material, in some embodiments, is less than or equal to 0.75 W/m·K. In some embodiments, the first material comprises aluminum.

In some embodiments, the cooler or cooling system comprises one or more heat sinks. At least a majority, by weight and/or volume, of each of the heat sink(s), in some embodiments, is a material having a thermal conductivity that is greater than or equal to 100 W/m·K. In some embodiments, for each of the TEC(s), the second surface of the TEC is fixed to one of the heat sink(s). In some embodiments, one or more openings are defined through the shell and, optionally, each of the heat sink(s) is disposed in one of the opening(s). Each of the heat sink(s), in some embodiments, comprises two or more fins that extend in a direction opposite the cavity and toward an exterior of the shell and are separated by one or more caps. Each of the heat sink(s), in some embodiments, is movable relative to the shell. In some methods, moving each of the TEC(s) between the first and second positions comprises moving each of the heat sink(s) relative to the shell.

In some embodiments, the cooler or cooling system comprises one or more actuators configured to move the TEC(s) between the first and second positions. In some embodiments in which the one or more TECs comprise two or more TECs, at least one of the actuator(s) is configured to move at least two of the TECs. Each of the actuator(s), in some embodiments, comprises one or more wires, each configured to shrink from a first length to a second length that is smaller than the first length when an electric current flows through the wire. In some of such embodiments, the actuator(s) are configured to move the TEC(s) from the first position to the second position when each of the wire(s) shrinks from the first length to the second length. In some embodiments, at least one of the actuator(s) comprises a spin plate and, for each of the TEC(s), a rod coupled to the TEC and slidably disposed in a slot defined by the spin plate. The slot, in some of such embodiments, is shaped such that when the spin plate rotates in a first direction the rod disposed in the slot translates toward the container and the TEC coupled to the rod moves from the first position to the second position. In some methods, moving the TEC(s) between the first and second positions comprises actuating the actuator(s). In some of such methods where each of the actuator(s) comprises one or more wires that each is configured to shrink from a first length to a second length, actuating the the actuator(s) comprises directing an electric current through each of the wire(s). In some of such methods where at least one of the actuator(s) comprises the spin plate and rod(s), actuating the actuator(s) comprises rotating the spin plate in the first direction.

In some embodiments, the cooler or cooling system comprises one or more temperature sensors, each configured to measure a temperature within the cavity and/or a controller. The controller, in some embodiments, is configured to receive a temperature measurement from each of the temperature sensor(s) and actuate the actuator(s) and thereby move each of the TEC(s) between the first and second positions based at least in part on the temperature measurement(s). Some methods comprise receiving a temperature measurement from each of the temperature sensor(s) and, in some of such methods, actuating the actuator(s) is performed based at least in part on the temperature measurement(s).

In some embodiments, the cooler comprises a thermally insulating material disposed in the cavity. In some of such embodiments, the thermally insulating material has a thermal conductivity less than or equal to 0.10 W/m·K and/or is an aerogel.

In some embodiments, the cooler or cooling system comprises an electric power source configured to deliver an electric current to each of the TEC(s). The electric power source, in some embodiments, has a capacity that is between 40 and 115 Watt-hours.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed embodiment, the terms “substantially” and “about” may be substituted with “within [a percentage] of” what is specified, where the percentage includes 0.1, 1, 5, and 10 percent.

The terms “comprise” and any form thereof such as “comprises” and “comprising,” “have” and any form thereof such as “has” and “having,” and “include” and any form thereof such as “includes” and “including” are open-ended linking verbs. As a result, an apparatus that “comprises,” “has,” or “includes” one or more elements possesses those one or more elements, but is not limited to possessing only those elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/include/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Further, a device or system that is configured in a certain way is configured in at least that way, but it can also be configured in ways other than those specifically described.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers. Views in the figures are drawn to scale, unless otherwise noted, meaning the sizes of the depicted elements are accurate relative to each other for at least the embodiment in view.

FIG. 1A is a perspective view of a first embodiment of the present coolers.

FIG. 1B is a top view of the cooler of FIG. 1A with the lid of the cooler's shell removed. FIG. 1B illustrates the receptacles of the cooler's container that is disposed in the cavity of the shell.

FIGS. 1C-1F are front, right, back, and left views, respectively, of the cooler of FIG. 1A. As shown, the cooler has two heat sinks, each disposed in a respective opening defined through the cooler's shell.

FIGS. 1G and 1H are a sectional views of the cooler of FIG. 1A taken along line 1G-1G of FIG. 1D and illustrate the arrangement of the cooler's TECs, actuators, and container in the cavity, including two of the container's receptacles. FIG. 1H shows vaccine-containing vials disposed in the container's receptacles.

FIGS. 2A and 2B are sectional views of the cooler of FIG. 1A taken along line 2A-2A of FIG. 1C and illustrate the cooler's TECs moving from a first position in which the TECs do not contact the container (FIG. 2A) to a second position in which the TECs contact a container (FIG. 2B) as wires of the cooler's actuators shrink from a first length to a second length that is shorter than the first length.

FIGS. 2C and 2D are sectional views of the cooler of FIG. 1A taken along line 2C-2C of FIG. 1D and illustrate the cooler's TECs moving from the first position (FIG. 2C) to the second position (FIG. 2D).

FIG. 2E is a schematic showing a TEC that can be used with some of the present coolers electrically connected to a power source of a cooler.

FIGS. 3A-3C are perspective, top, and left views, respectively, of a second embodiment of the present coolers that is substantially the same as the cooler of FIG. 1A except for the actuation mechanism by which its TECs are moved between the first and second positions.

FIGS. 3D and 3E are sectional views of the cooler of FIG. 3A taken along line 3D-3D of FIG. 3C and illustrate the cooler's TECs moving from the first position (FIG. 3D) to the second position (FIG. 3E) when the cooler's spin disk rotates clockwise. As shown, the spin disk includes slots that each receives a rod coupled to one of the TECs and is shaped such that clockwise rotation of the spin disk causes translation of the rod and thus the TEC toward the container.

FIGS. 3F and 3G are sectional views of the cooler of FIG. 3A taken along line 3F-3F of FIG. 3B and illustrate the cooler's TECs moving from the first position (FIG. 3F) to the second position (FIG. 3G).

FIG. 3H is a sectional view of the cooler of FIG. 3A taken along line 3H-3H of FIG. 3B and illustrates the arrangement of one of the TECs, heat sinks, and rods relative to the spin disk.

FIG. 3I is a top view of the spin disk of the FIG. 3A cooler and shows the geometry of its slots.

FIG. 4 is a sectional view of the cooler of FIG. 1A taken along line 4-4 of FIG. 1D and shows the cooler's controller.

FIG. 5 is a block diagram of steps that a controller of some of the present coolers can perform.

FIG. 6 shows an experimental setup comparing the cooling performance of a TEC that is fixed to a test bed (“System A”) to the cooling performance of a TEC that is movable relative to a test bed such that the TEC can retract away from the test bed when the TEC is deactivated (“System B”).

FIG. 7 is a graph showing the temperature of the test beds over time in the experiment shown in FIG. 6. The graph indicates that System B with its movable TEC was able to achieve more stable temperature control and consume less energy.

### DETAILED DESCRIPTION

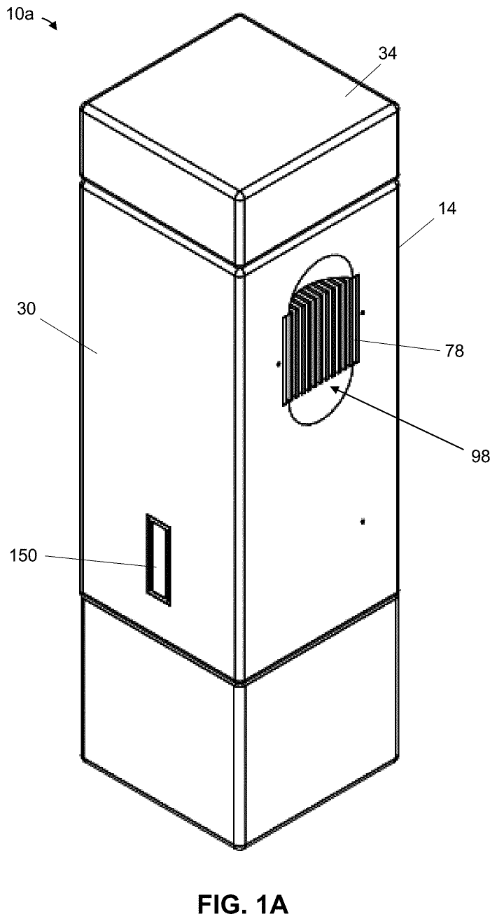

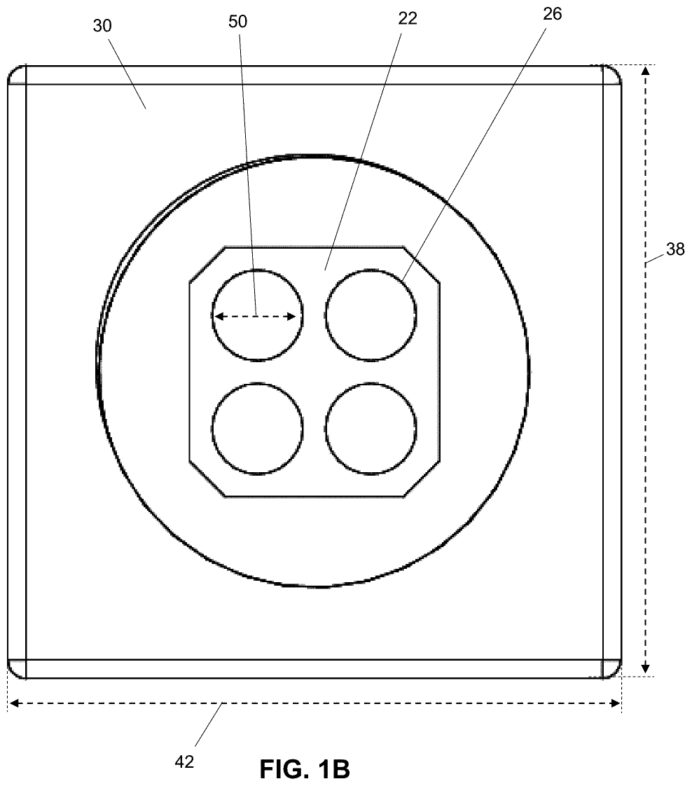

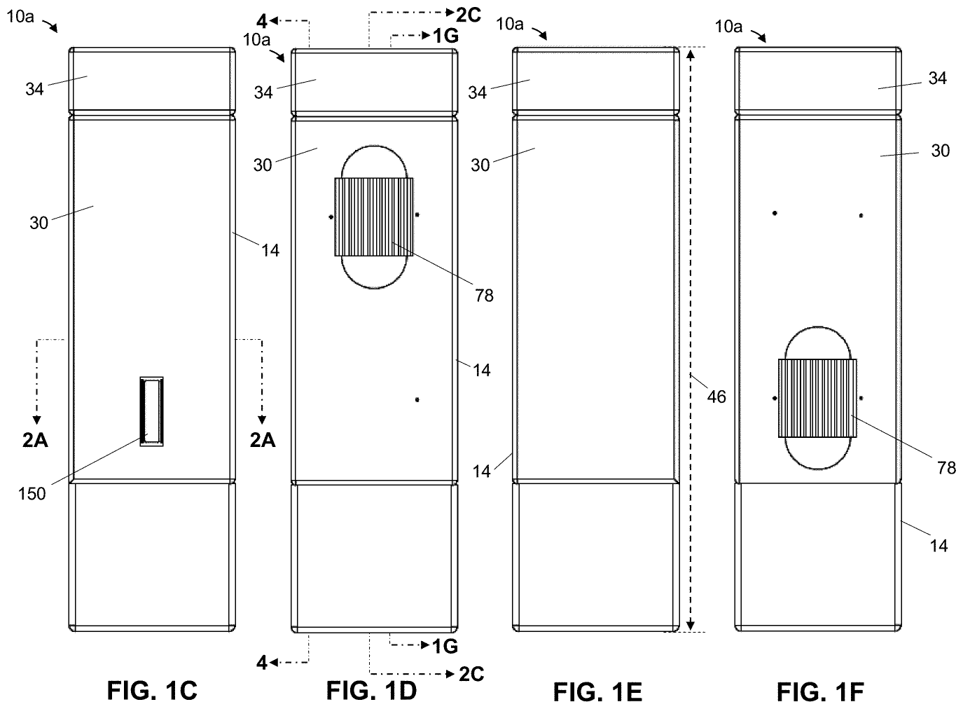

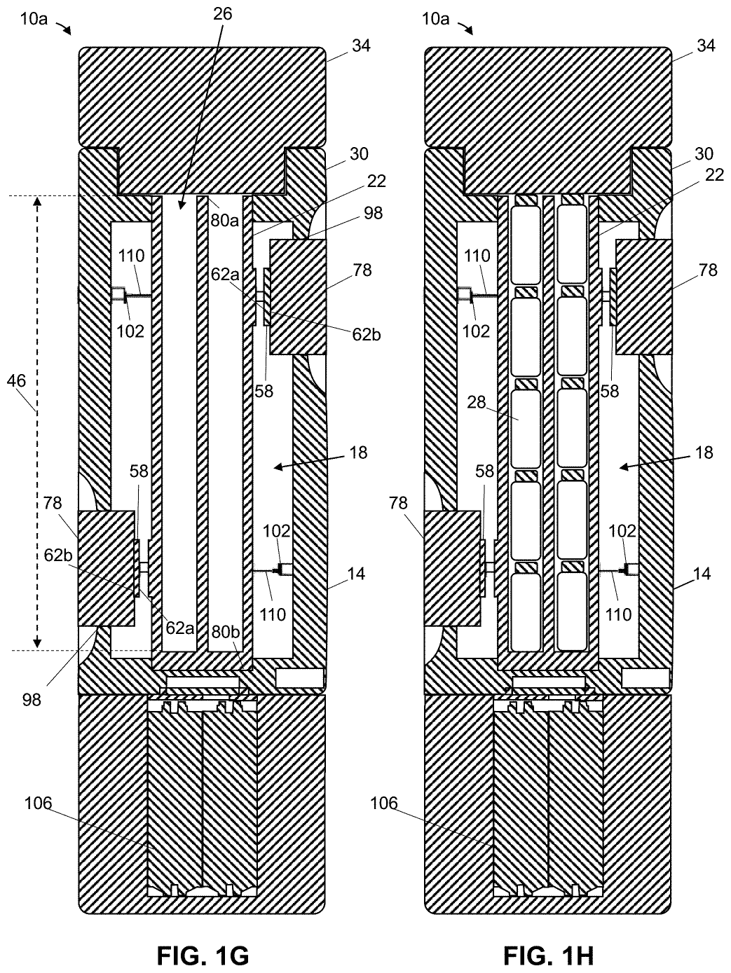

Referring to FIGS. 1A-1H, shown is a first embodiment 10a of the present coolers. Cooler 10a can comprise a shell 14 that defines a cavity 18 configured to receive a container 22. Container 22 can hold one or more items for transport, such as food, beverages, medications, organs, blood, vaccines, and/or the like. For example, container 22 can define greater than or equal to any one of or between any two of 1, 2, 3, 4, 5, 6, or 7 receptacles 26 (e.g., greater than or equal to 4 receptacles), each of which can receive one or more items. As shown, each of receptacle(s) 26 is configured to receive one or more vials 28 (e.g., that contain a vaccine). To permit access to receptacle(s) 26 and/or removal of container 22, shell 14 can comprise a body 30 in which the container can be disposed and a lid 34 removably coupled to the body (e.g., with threads). When lid 34 is removed, receptacle(s) 26 can be accessed such that items can be inserted into or removed from the receptacle(s) (FIG. 1B).

Cooler 10a can be relatively compact to facilitate transportability. For example, shell 14 can have a length 38 and a width 42 measured perpendicularly to the length, each of which can be less than or equal to any one of or between any two of 12, 11, 10, 9, 8, 7, 6, 5, or 4 inches (e.g., between 4 and 8 inches). And a height 46 of shell 14, measured perpendicularly to length 38 and width 42, can be less than or equal to any one of, or between any two of, 36, 32, 28, 24, 20, 16, or 12 inches (e.g., between 16 and 32 inches). The compactness of cooler 10a can be facilitated at least in part by the below-described cooling system, which can maintain refrigeration for relatively long periods of time without the need for a container sized to accommodate large amounts of cooling material.

As described above, each of receptacle(s) 26 can be sized to accommodate one or more vials 28 that contain a vaccine (FIGS. 1G and 1H). To illustrate, a transverse dimension 50 of each of receptacle(s) 26 can be greater than or equal to any one of, or between any two of, 0.60, 0.80, 1.0, 1.2, 1.4, 1.6, or 1.8 inches (e.g., between 0.8 and 1.2 inches). Each of receptacle(s) 26 can also be sized to accommodate multiples vials 28. For example, a height 54 of each of receptacle(s) 26, measured perpendicularly to transverse dimension 50, can be greater than or equal to any one of, or between any two of, 6, 7, 8, 9, 10, 11, 12, 13, 14, or 15 inches (e.g., between 9 and 14 inches). As shown, container 22 defines four receptacles 26, each sized to hold five vials 28 such that cooler 10a can be used to transport twenty vials.

These dimensions are provided by way of illustration and are non-limiting. In other embodiments, shell 14 and container 22—and thus cavity 18 and receptacle(s) 26, respectively—can have any dimensions suitable to accommodate a particular item for transport. For example, if designed for organ transport container 22 can define receptacle(s) 26 that are larger than those shown in FIGS. 1G and 1H because organs tend to be larger than vaccine vials. Shell 14 can also be configured to receive different containers having differently-sized receptacles such that the same shell can be used to transport different items. And while cooler 10a can be relatively compact, in some embodiments it need not be as the below-described cooling system can provide benefits for both compact and non-compact coolers.

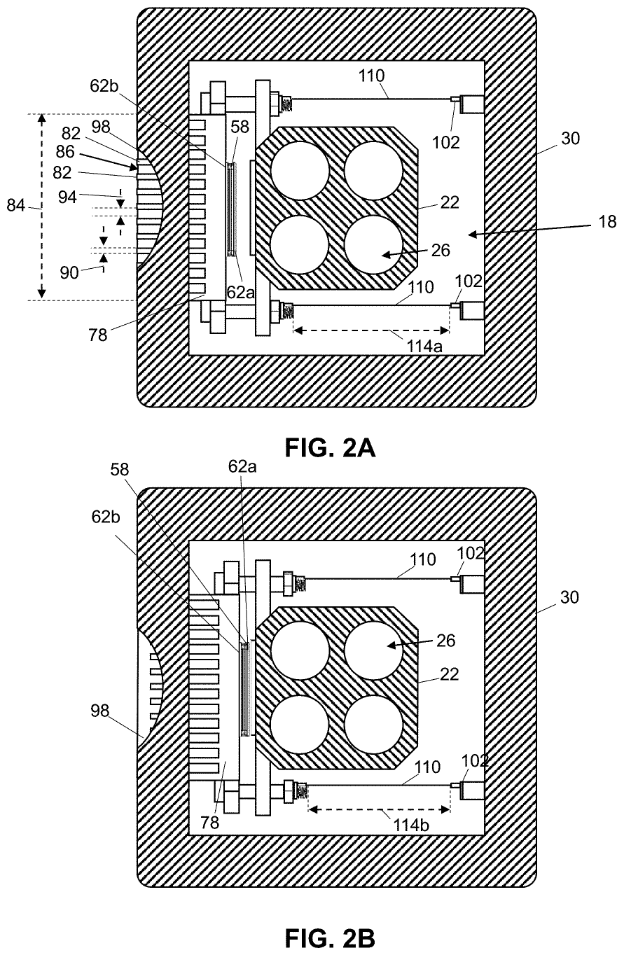

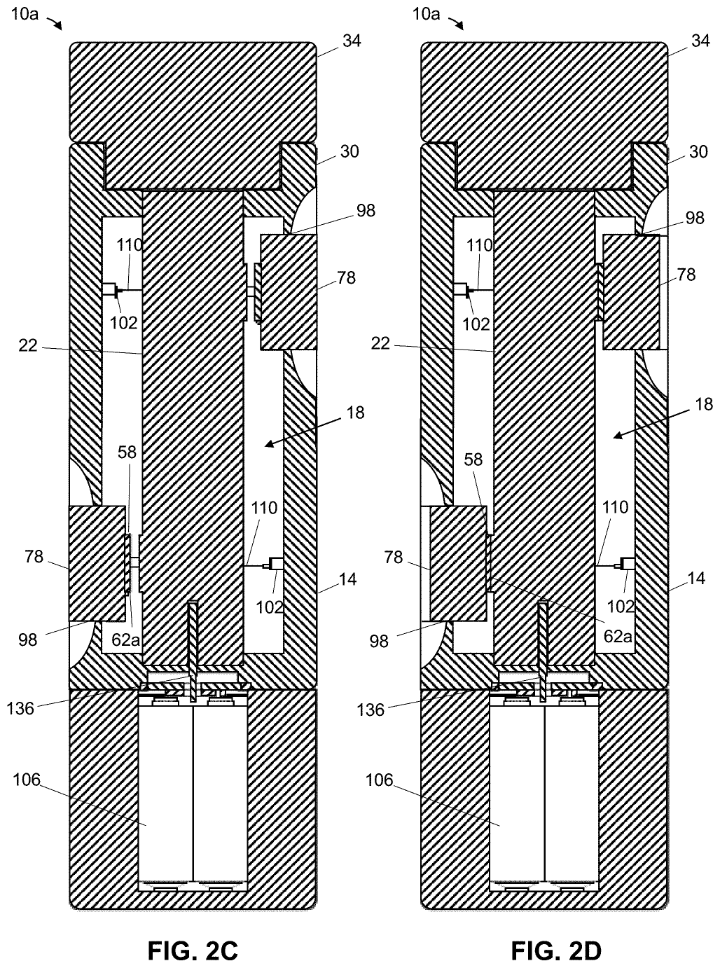

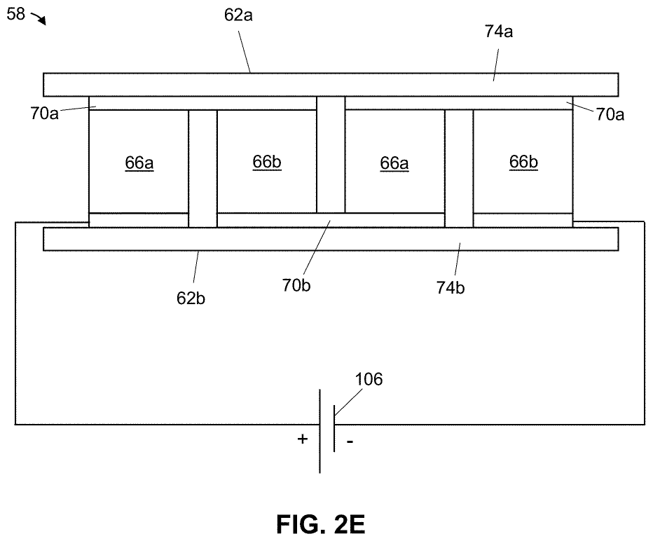

Referring additionally to FIGS. 2A-2E, the cooling system of cooler 10a can comprise one more thermoelectric coolers (e.g., Peltier devices) (“TEC”) 58, each having opposing first and second surfaces 62a and 62b. Each of TEC(s) 58 can be configured to contact container 22 with first surface 62a and to transfer heat from the first surface to second surface 62b when an electric current flows through the TEC to refrigerate the contents of the container. For example, each of TEC(s) 58 can include one or more first conductors 66a—such as N-Type semiconductors—and one or more second conductors 66b that are different than the first conductors (e.g., that have different electron densities), such as P-Type semiconductors (FIG. 2E). Due to the Peltier effect, heat can be absorbed when current flows from a first conductor 66a (e.g., an N-Type semiconductor) to a second conductor 66b (e.g., a P-Type semiconductor) and heat can be emitted when current flows from a second conductor to a first conductor. To achieve heat transfer from first surface 62a to second surface 62b—and thus to cool container 22—first and second conductors 66a and 66b can be electrically connected in series via one or more first connectors 70a and/or one or more second connectors 70b such that current flowing through TEC 58 flows alternatingly between the first and second conductors, e.g., for each of the first conductor(s), current is received from and/or is transferred to one of the second conductor(s). Each of first connector(s) 70a can be arranged such that current can flow from one of first conductor(s) 66a to one of second conductor(s) 66b via the first connector and can be disposed closer to first surface 62a than to second surface 62b such that—due to that current flow—the TEC can absorb heat through the first surface from container 22. Each of second connector(s) 70b can be arranged such that current can flow from one of second conductor(s) 66b to one of first conductor(s) 66a via the second connector and can be disposed closer to second surface 62b than to first surface 62a such that—due to that current flow—the TEC can emit heat through the second surface. In this manner, current flow through TEC 58 permits heat transfer from first surface 62a to second surface 62b to refrigerate the contents of container 22. Conductors 66a and 66b and connector(s) 70a and 70b can be disposed between first and second electrically insulating plates 74a and 74b (e.g., ceramic plates) to facilitate this heat transfer.

Container 22 can comprise a thermally conductive material such that heat can be readily transferred from the container to TEC(s) 58 while shell 14 can comprise a thermally insulating material to mitigate heat transfer from the environment to cavity 18 and thus the container. For example, at least a majority, by weight and/or volume, of container 22 can comprise a first material and at least a majority, by weight and/or volume, of shell 14 can comprise a second material having a thermal conductivity that is less than or equal to any one of, or between any two of, 90%, 80%, 70%, 60%, 50%, 40%, 30%, 20%, 10%, 5%, or 1% (e.g., less than or equal to 5%) of the thermal conductivity of the first material. To illustrate, the thermal conductivity of the first material can be greater than or equal to any one of, or between any two of, 50, 100, 150, 200, 250, 300, 350, 400, or 450 Watts per meter-Kelvin (W/m·K) (e.g., greater than or equal to 100 W/m·K) and the thermal conductivity of the second material can be less than or equal to any one of, or between any two of, 1.0, 0.75, 0.50, 0.25, 0.10, 0.05, or 0.03 W/m·K (e.g., less than or equal to 0.75 W/m·K). The first material can comprise, for example, aluminum, copper, and/or the like. The second material can comprise a polymer and/or foam, such as acetal (i.e., polyoxymethylene), polyethylene, polyurethane, polystyrene, and/or the like. Some shell materials, such as acetal, can be relatively durable and thus can render shell 14 damage resistant when incorporated in the shell.

Cooler 10a can also comprise a thermally-insulating material in cavity 18 (e.g., between container 22 and shell 14) that can further mitigate heat transfer from the environment to the container through the shell. The thermally-insulating material can have a thermal conductivity that is less than that of shell 14, such as less than or equal to any one of, or between any two of, 0.50, 0.25, 0.10, 0.05, or 0.03 W/m·K (e.g., less than or equal to 0.10 W/m·K). For example, the thermally-insulating material can comprise an aerogel and/or a foam and can be less durable than shell 14 (e.g., because it need not absorb the same loads as the shell). Such a thermally-insulating material, however, can be omitted. In some embodiments, a vacuum can be defined in the space between container 22 and shell 14 (e.g., such that that space is substantially free of gas). In other embodiments, a cooling material such as ice (e.g., in the form of one or more ice packs) can be disposed in cavity 18 to supplement the cooling provided by TEC(s) 58.

Each of TEC(s) 58 can be relatively compact at least in part because the TEC may not require moving parts to achieve cooling. For example, first surface 62a and/or second surface 62b can each have an area that is less than or equal to any one of, or between any two of, 10, 9, 8, 7, 6, 5, 4, 3, 2, or 1 square inches (e.g., less than or equal to 3 square inches). And a thickness of each of TEC(s) 58, measured between first and second surfaces 62a and 62b, can be less than or equal to any one of, or between any two of, 0.50, 0.40, 0.30, 0.20, or 0.10 inches (e.g., less than or equal to 0.30 inches).

The cooling system can also include one or more heat sinks 78 (e.g., a heat sink for each of TEC(s) 58) where second surface 62b of each of TEC(s) 58 can be configured to contact or be fixed to one of the heat sink(s) such that the heat absorbed by the TEC from container 22 can be dissipated to the environment at a rate that might not otherwise be achievable using the TEC(s) alone due to their small form factor. This can promote continued cooling of container 22 by mitigating the accumulation of heat in TEC(s) 58 and/or within cavity 18. To promote heat dissipation, each of heat sink(s) 78 can include two or more fins 82 separated by one or more gaps 86, where each of the fins and gap(s) has a width 90 and 94, respectively, that is less than or equal to any one of, or between any two of, 20%, 15%, 10%, 5%, or 1% (e.g., less than or equal to 10%) of a width 84 of the heat sink (e.g., where each of the widths is measured in a direction parallel to second surface 62b of a TEC 58 connected thereto) (FIG. 2A). Each of heat sink(s) 78 can be disposed in a respective one of one or more openings 98 defined through shell 14 such that fins 82 extend in a direction opposite cavity 18 and toward an exterior of the shell (e.g., in a direction perpendicular to second surface 62b of a TEC 58 connected thereto). As such, fins 82 can define a relatively large surface area exposed to the exterior environment to promote faster rates of heat dissipation. In this manner, heat sink(s) 78 can provide an avenue for heat to exit the interior of cooler 10a despite the cooler having a thermally-insulating shell 14.

Heat sink(s) 78 can be relatively large compared to TEC(s) 58 to facilitate heat transfer away from the TEC(s) and thus from container 22. To illustrate, for each of heat sink(s) 78 an area of the heat sink's surface to which second surface 62b of a TEC 58 is attached can be greater than or equal to any one of, or between any two of, 50%, 100%, 150%, 200%, 250%, 300%, 350%, 400%, 450%, or 500% (e.g., greater than or equal to 250%) of the area of the second surface, such as greater than or equal to any one of, or between any two of, 7, 8, 9, 10, 11, 12, 13, 14, 15, 16, or 17 square inches (e.g., greater than or equal to 7.5 square inches). And a thickness of each of heat sink(s) 78 (e.g., measured in a direction perpendicular to second surface 62b of a TEC 58 connected thereto) can be greater than or equal to any one of, or between any two of, 150%, 200%, 250%, 300%, 350%, 400%, 450%, 500%, 550%, or 600% (e.g., greater than or equal to 400%) of the thickness of the TEC, such as greater than or equal to any one of, or between any two of, 0.9, 1.0, 1.1, 1.2, 1.3, 1.4, 1.5, 1.6, 1.7, 1.8, 1.9, or 2.0 inches (e.g., greater than or equal to 1.2 inches).

Heat sink(s) 78 can comprise a thermally conductive material to promote the dissipation of heat from TEC(s) 58 to the environment, e.g., at least a majority of each of the heat sink(s), by weight and/or volume, can be a material having a thermal conductivity that is greater than or equal to any one of, or between any two of, 50, 100, 150, 200, 250, 300, 350, 400, or 450 W/m·K. Such a material can comprise, for example, aluminum and/or copper.

Any suitable number of TEC(s) 58 and heat sink(s) 78 can be used to cool container 22, such as greater than or equal to any one of or between any two of one, two, three, four, five, six, seven, eight, nine, or ten TEC(s) or heat sink(s). As shown, there are two TEC(s) 58, each fixed to a respective heat sink 78. When cooler 10a includes two or more TECs 58, those TECs can be spaced apart to facilitate uniform cooling of container 22. For example, container 22 can have opposing first and second ends 80a and 80b and at least one of TECs 58 can be disposed closer to the first end than the second end (e.g., separated from the first end by a distance that is less than or equal to 30% of the container's length 46) and at least one of the TECs can be disposed closer to the second end than the first end (e.g., separated from the second end by a distance that is less than or equal to 30% of the container's length).

TEC(s) 58 may not need to continuously operate to maintain a desired temperature within cavity 18 (e.g., in receptacle(s) 26). However, because each of TEC(s) 58 is configured to transfer heat from first surface 62a to second surface 62b, the temperature of the first surface can be lower than that of the second surface when current flows through the TEC; due to this temperature difference, heat may tend to transfer back to the first surface when current flow stops. To mitigate any heat transfer back to container 22 when this occurs, each of TEC(s) 58 can be movable between a first position in which first surface 62a does not contact container 22 (FIGS. 2A and 2C) and a second position in which the first surface contacts the container (FIGS. 2B and 2D). Each of heat sink(s) 78 can also be movable relative to shell 14 with TEC(s) 58 such that the TEC(s) remain fixed to the heat sink(s) during movement. When a TEC 58 is operating to cool container 22, it can be moved to the second position such that it contacts and thus conducts heat away from the container. When a TEC 58 is not operating, it can be moved to the first position such that residual heat that may flow from second surface 62b to first surface 62a is not conducted to container 22. By mitigating such undesired heat transfer to container 22, TEC(s) 58 need not operate as often to maintain a desired refrigeration temperature˜relative to if the TEC(s) were fixed to the container˜such that the energy required to do so is significantly lower. Additionally, this operation can promote stable temperature control that may otherwise be difficult to maintain if residual heat is transferred back to container 22 when TEC(s) 58 are off. As a result, cooler 10a can maintain adequate refrigeration for longer periods time and can be more compact and lighter compared to conventional coolers because it need not use large quantities of cooling material.

TEC(s) 58 can be moved between the first and second positions using one or more actuators 102. Each of actuator(s) 102 can comprise any suitable actuator, such as a mechanical actuator, a pneumatic actuator, a hydraulic actuator, and/or the like, and can be powered by an electric power source 106 (e.g., one or more batteries) of cooler 10a that can also deliver current to TEC(s) 58. As shown, each of actuator(s) 102 comprises a wire 110 configured to shrink from a first length 114a (FIG. 2A) to a second length 114b (FIG. 2B) that is shorter than the first length when an electric current flows through the wire. Each of wire(s) 110 can comprise a shape memory alloy, such as nickel titanium, to achieve its shrinkability (e.g., such that the wire, when heated by, for example, an electric current flowing therethrough, shrinks from first length 114a to second length 114b and, when cooled from that heated temperature, expands from the second length to the first length). Shrinkage of wire(s) 110 can cause TEC(s) 58 to move from the first position to the second position. For example, for each of wire(s) 110, a first end of the wire can be coupled to shell 14 and a second end of the wire can be coupled to one of heat sink(s) 78 such that when the wire shrinks the heat sink and thus a TEC 58 connected thereto move towards container 22. To retract TEC(s) 58 to the first position, current flow through wire(s) 110 can be stopped such that each of the wire(s) extends to first length 114a. Such wire(s) 110 can promote reliability (e.g., by allowing actuation with fewer moving parts, compared to other actuation mechanisms) and space and weight savings (e.g., because the wire(s) need not occupy significant space in cavity 18 and can be relatively light).

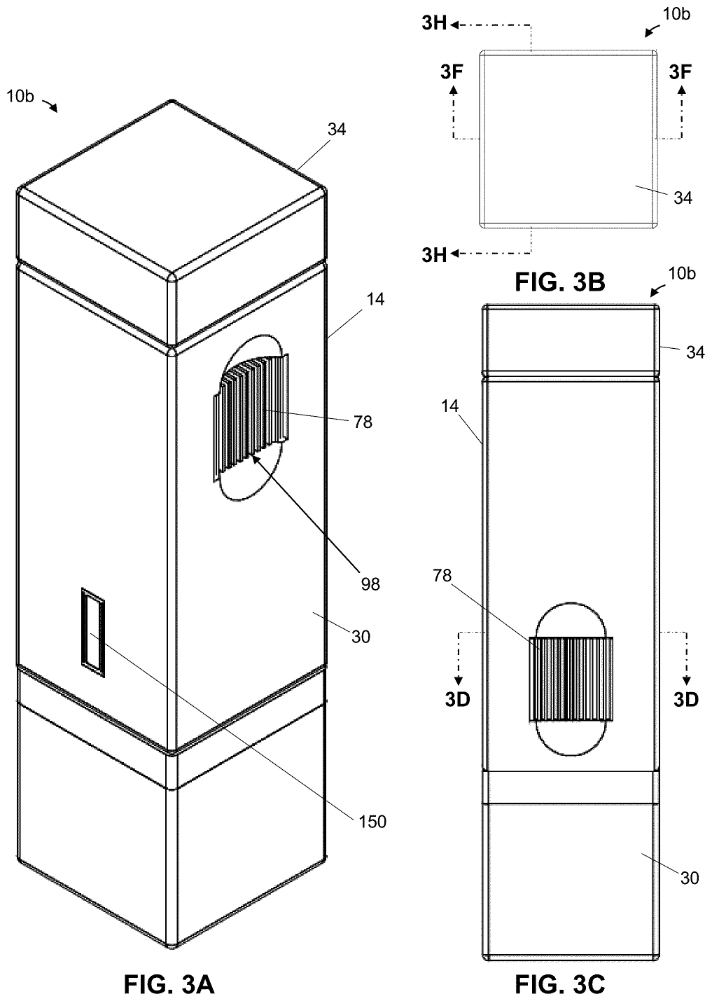

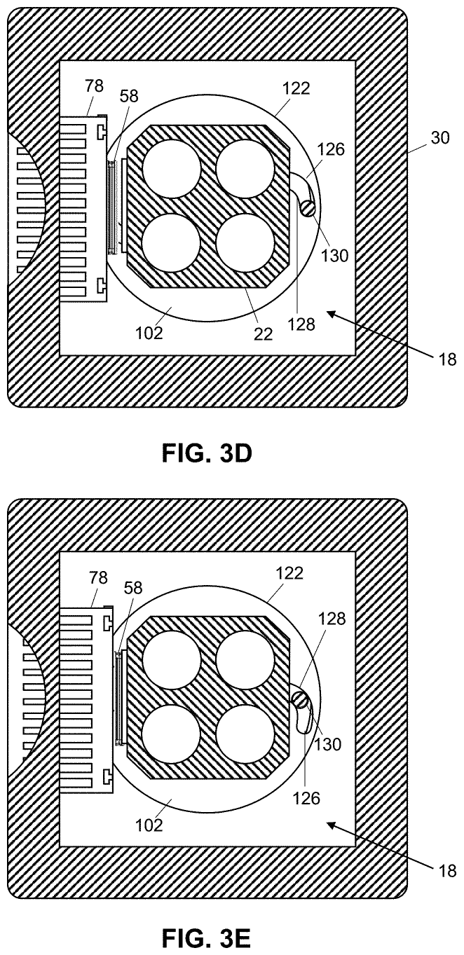

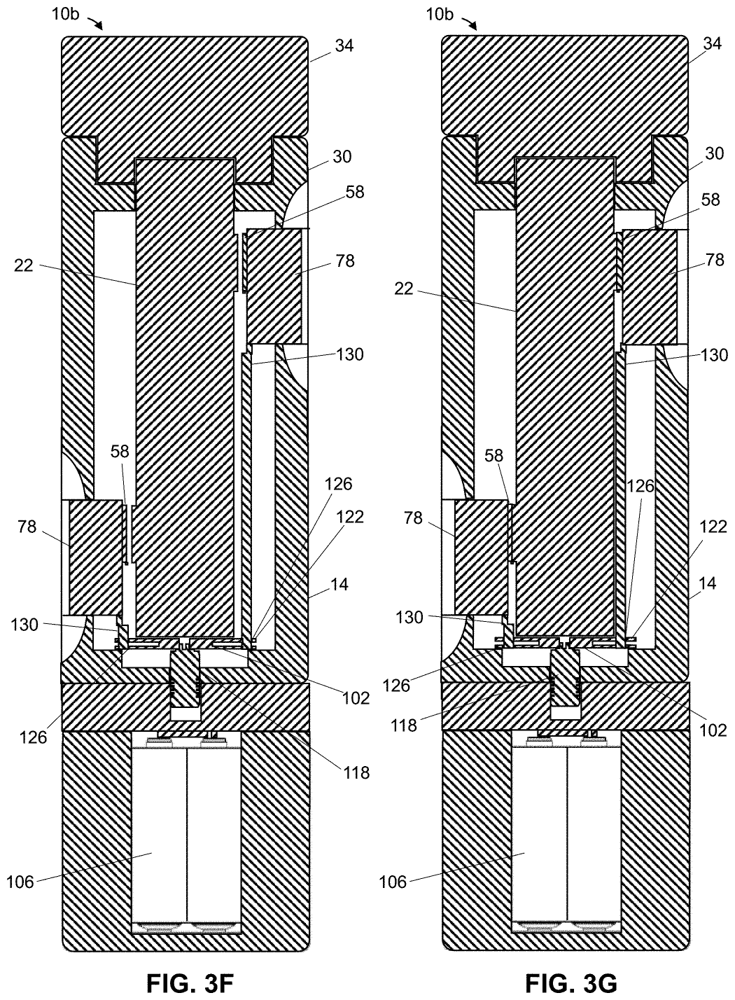

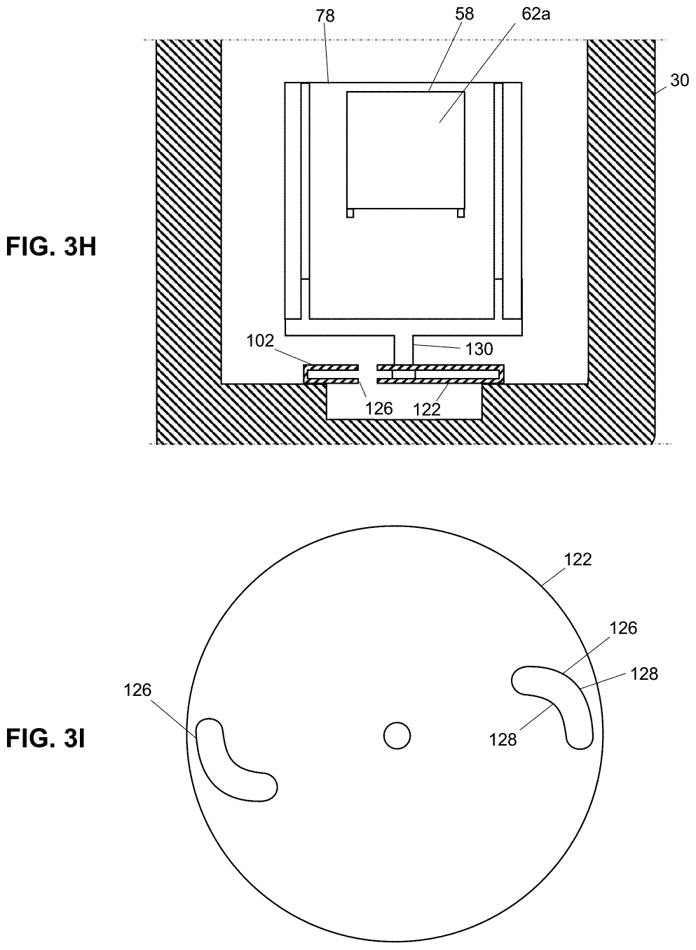

Another illustrative actuator 102 that can be used to move TEC(s) 58 between the first and second positions is incorporated in a second embodiment 10b of the present coolers that is shown in FIGS. 3A-3I and is substantially similar to cooler 10a, the primary exception being the actuation mechanism. As shown, actuator 102 comprises a motor 118 and a spin plate 122 configured to be rotated by the motor (FIGS. 3F and 3G). Spin plate 122 can define one or more slots 126 (FIG. 3I), where a rod 130 that is coupled to one of TEC(s) 58 (e.g., via one of heat sink(s) 78 that is attached to the rod) is received in each of the slot(s) (FIGS. 3D-3H) such that the rod can slide along one or more arcuate bearing surfaces 128 that at least partially define the slot. Each of slot(s) 126 can be shaped such that rotation of spin plate 122 causes rod 130—and thus TEC 58 and heat sink 78 that are coupled thereto—to translate relative to the spin plate's center. For example, rotating spin plate 122 in a first direction can cause rod 130, TEC 58, and heat sink 78 to move in a direction toward the spin plate's center such that the TEC moves from the first position (FIGS. 3D and 3F) to the second position (FIGS. 3E and 3G) and rotating the spin plate in a second direction opposite the first direction can cause the opposite movement (e.g., such that the TEC retracts from the second position to the first position). As shown, spin plate 122 defines a slot 126 for each of TECs 58 such that rotation of the plate can cause simultaneous movement of the two TECs. Such an actuator 102—with its motor 118 and spin plate 122—may facilitate precise control over the location of TEC(s) 58 and can move the TEC(s) between the first and second positions relatively quickly in response to an actuation signal, thereby mitigating latencies.

These actuators are provided by way of illustration and are non-limiting. In other embodiments, each of actuator(s) 102 can comprise any suitable components to move TEC(s) 58 between the first and second positions, such as one or more motors, gears, valves, pistons, and/or the like. For example, each of actuator(s) 102 of cooler 10a can comprise, instead of wire 110, a linear actuator with a pneumatically- or hydraulically-driven piston or with a motor that rotates two or more gears to cause translational movement of a linkage. And any suitable number of actuator(s) 102 can be used to move TEC(s) 58 simultaneously or independently of one another. For example, in cooler 10a two actuators 102—and thus two wires 110—are coupled to each of heat sinks 78 to move both the heat sink and TEC 58, while in cooler 10b a single actuator 102 brings about movement of both TECs as described above. In some embodiments, actuator(s) 102 can move TEC(s) 58 passively (e.g., without powering the actuator(s)); for example, if each of the actuator(s) comprises a wire whose length can change in response to temperature, the wire(s) can be positioned and comprise materials such that an increase in the temperature in cavity 18 (e.g., which may warrant activation of the TEC(s) for cooling) yields a change in the wire(s)'s length(s) such that the TEC(s) move toward container 22 while a decrease in the temperature of the cavity (e.g., which may warrant deactivation of the TEC(s)) yields a change in the wire(s)'s length(s) such that the TEC(s) move away from the container.

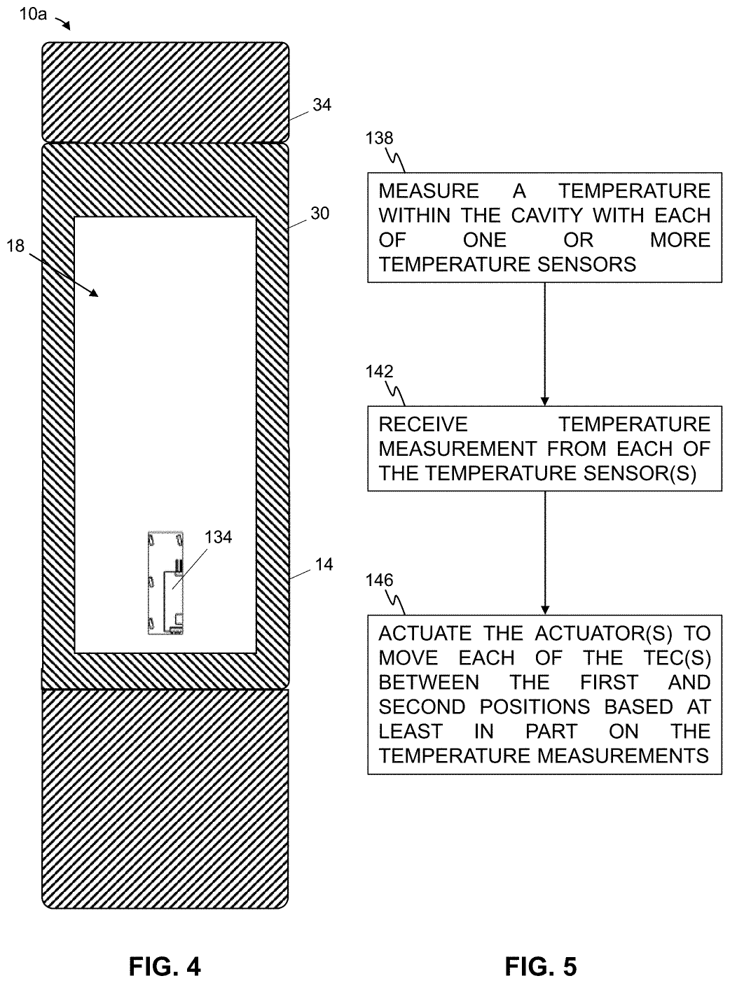

Referring to FIGS. 4 and 5, TEC(s) 58 and actuator(s) 102 can be controlled with a controller 134 of the cooler (e.g., 10a or 10b). For example, the cooler can include one or more sensors, such as one or more temperature sensors 136 that each is configured to measure a temperature within cavity 18, such as a temperature within at least one of receptacle(s) 26 of container 22, a temperature of the container (e.g., in its interior and/or at its surface), a temperature in the space between the container and shell 14, or a temperature of the inner surface of the shell. To illustrate, as shown cooler 10a comprises a single temperature sensor in contact with and configured to measure the temperature of container 22 (FIGS. 2C and 2D). Controller 134 can be configured to, for each of the temperature sensor(s), perform a step 138 of measuring such a temperature with the temperature sensor and a step 142 of receiving the temperature measurement therefrom. Based at least in part on those temperature measurement(s), controller 134 can be configured to perform a step 146 of actuating actuator(s) 102 to move each of TEC(s) 58 between the first and second positions. For example, those temperature measurement(s) can indicate that additional cooling is required to maintain the temperature of container 22 within a target temperature and, when this occurs, controller 134 can actuate actuator(s) 102 such that TEC(s) 58 move to the second position and permit electric current to flow to the TEC(s) such that the TEC(s) cool the container. Those temperature measurement(s) can also indicate when further cooling is not needed to maintain the temperature of container 22 within a target temperature and, when this occurs, controller 134 can stop electric current flow to TEC(s) 58 and actuate actuator(s) 102 such that the TEC(s) move to the first position. Controller 134 can monitor the temperature measurement(s) and turn the cooling system on and off (e.g., by actuating actuator(s) 102 and activating/deactivating TEC(s) 58 as set forth above) to maintain appropriate refrigeration to preserve items within container 22 and conserve energy. Controller 134 can also be powered by power source 106.

The cooling system can be configured to maintain a temperature in cavity 18 that is less than or equal to any one of or between any two of 15, 12, 9, 6, 3, or 1° C. (e.g., between 2 and 8° C.) for a time period that is greater than or equal to any one of, or between any two of, 5, 10, 15, 20, 25, or 30 hours (e.g., at least 15 or 30 hours) (e.g., when the temperature of the ambient environment is at least 25° C.). Power source 106 can have an adequate capacity to power the cooling system—including TEC(s) 58, actuator(s) 102, and/or controller 134—for such durations and/or the power source can be rechargeable and/or replaceable. For example, the capacity of power source 106 can be greater than or equal to any one of, or between any two of, 35, 40, 45, 50, 55, 60, 65, 70, 75, 80, 85, 90, 95, 100, 105, 110, 115, 120, 125, 130, 135, 140, 145, or 150 Watt-hours (W-h) (e.g., between 40 and 115 W-h). One or more photovoltaic cells can be disposed on an exterior surface of shell 14 and can be configured to charge power source 106; this can extend the life of the power source during transit such that refrigeration can be maintained for a longer period of time. Power source 106 can also be removed from the cooler and replaced in transit; unlike cooling material such as ice that is perishable and thus difficult to replenish during transportation, additional power source(s) (which can be the same as power source 106) can be readily transported and used to replace a dead power source in transit to provide the power needed for the cooling system and thereby extend refrigeration. These long refrigeration times are achievable with the use of relatively compact power sources due at least in part to the efficient operation of the cooling system, thereby allowing the cooler to be used to transport items requiring refrigeration over long distances.

The cooling system need not be integrated into a specific cooler, e.g., it can be provided as a separate component (e.g., with its TEC(s) 58, heat sink(s) 78, actuator(s) 102, power source 106, and/or controller 134) that is configured to be incorporated into a cooler as described above. Such a cooling system can be modular, e.g., actuator(s) 102 can be configured to be removably coupled to a shell 14 of a cooler that can receive a container 22 such that TEC(s) 58 are movable between the above-described first and second positions. This modularity may allow the cooling system to be used with different coolers.

Coolers 10a and 10b can also each include a display 150 (e.g., a liquid crystal display) viewable from the exterior of shell 14. Display 150 can show one or more operating parameters, such as the target temperature, the current measured temperature, the remaining life of power source 106, and/or the like. One or more buttons or other interactive mechanisms can be disposed on shell 14's exterior and may allow a user to select a desired refrigeration temperature or temperature range.

Some of the present methods of refrigerating one or more items (e.g., 28), such as one or more vials that each contains a vaccine (e.g., a vaccine for diphtheria, influenza, hepatitis A, hepatitis B, measles, mumps, HIB, pertussis, tetanus, yellow fever, and/or the like) include a step of disposing the item(s) in one or more receptacles (e.g., 26) of a container (e.g., 22). The item(s) can be disposed in the receptacle(s) while the container is disposed in a cavity (e.g., 18) defined by a shell (e.g., 14) of a cooler (e.g., 10a or 10b) or before the container is placed in the cavity; for the latter, the container can be placed in the cavity after the item(s) are disposed therein. After the item(s) are disposed in the receptacle(s) and the container is disposed in the cavity, a lid (e.g., 34) of the shell can be coupled to a body (e.g., 30) of the shell to enclose the cavity. The cooler and its shell and container can be any of those described above.

To refrigerate the item(s), some methods comprise a step of moving each of one or more TECs (e.g., 58) (e.g., any of those described above) having opposing first and second surfaces (e.g., 62a and 62b) from a first position in which the first surface does not contact the container to a second position in which the first surface contacts the container. An electric current can be directed through each of the TEC(s) (e.g., from an electric power source 106 of the cooler, such as any of those described above) such that heat is transferred from the first surface to the second surface, thereby cooling the container and the item(s) disposed therein. Some methods comprise a step of stopping electric current flow through each of the TEC(s) and moving each of the TEC(s) from the second position to the first position. Movement of the TEC(s) between the first and second positions can be achieved with one or more actuators (e.g., 102) in any of the manners described above.

The TEC(s) can be moved between the first and second positions and electric current flow therethrough can be started and stopped any suitable number of times based at least in part on one or more temperature measurements from within the cavity (e.g., in the receptacle(s), at the surface of the container, in the space between the container and the shell, and/or at an interior surface of the shell) (e.g., using controller 134). Refrigeration can be performed such that a temperature in the cavity (e.g., an average of the temperature measurement(s)) is maintained within a target range that can be selected by a user, such as less than or equal to any one of or between any two of 15, 12, 9, 6, 3, or 1° C. (e.g., between 2 and 8° C.), for a time period that is greater than or equal to any one of, or between any two of, 5, 10, 15, 20, 25, or 30 hours (e.g., at least 15 or 30 hours) (e.g., when the temperature of the ambient environment is at least 25° C.). The power source need not be replaced for another power source over the cooling period (whether or not the power source is charged, such as with one or more photovoltaic cells on the shell's exterior), although in other methods the power source can be changed with one or more additional powers sources as described above.

Refrigeration with the TEC(s) may allow precise control of the cavity temperature. For example, a temperature in the cavity can be maintain within less than or equal to any one of or between any two of 0.2, 0.18, 0.16, 0.14, 0.12, 0.10, or 0.08° C. of a target temperature (e.g., any of those described above) for a time period that is at least 5, 10, 15, 20, 25, 30, 35, 40, 45, or 50 minutes.

### EXAMPLES

The present invention will be described in greater detail by way of specific examples. The following examples are offered for illustrative purposes only and are not intended to limit the invention in any manner. Those of skill in the art will readily recognized a variety of noncritical parameters that can be changed or modified to yield essentially the same results.

### Example 1

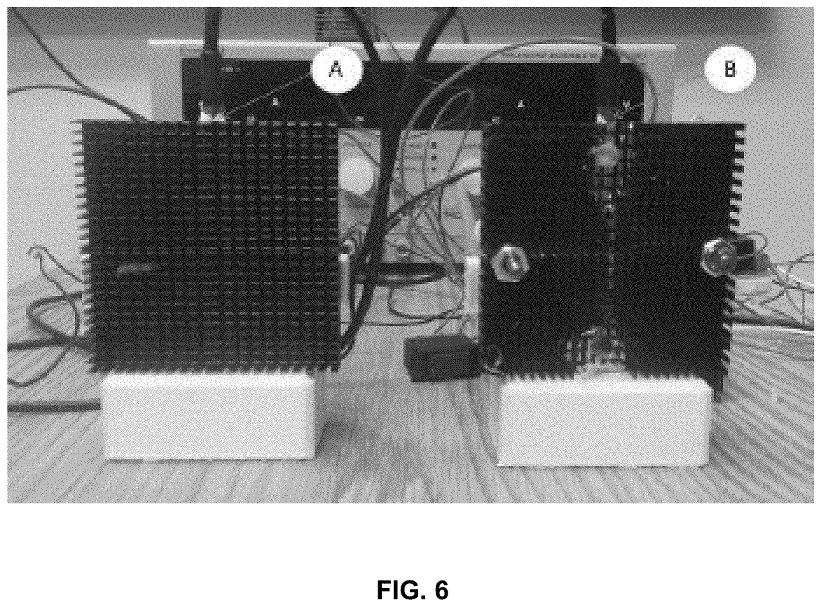

Referring to FIG. 6, two systems were tested to assess the ability of each to cool a test bed: a system in which a TEC was fixed to the test bed (“System A”) and a system in which a TEC was configured to move between a first position in which the TEC did not contact the test bed and a second position in which the TEC contacted the test bed (“System B”). For each, the test bed was a block of stainless steel that was 2 inches wide, 4 inches long, and 0.5 inches deep, a heated surface of the TEC was fixed to a heat sink to dissipate heat that was absorbed by the TEC's cooling surface and transferred to its heated surface, and a temperature sensor was connected to the test bed. A controller was programmed and used to control electric current delivery to each of the TECs such that the TEC would operate to maintain the test block at 10° C. (e.g., to activate and deactivate the TEC when cooling was and was not required, respectively). For System B, the controller was programmed to move the TEC to the second position to contact and thereby cool the test bed when the TEC was activated and to move the TEC to the first position away from the test bed when the TEC was deactivated. The test was performed over a period of 737 seconds.

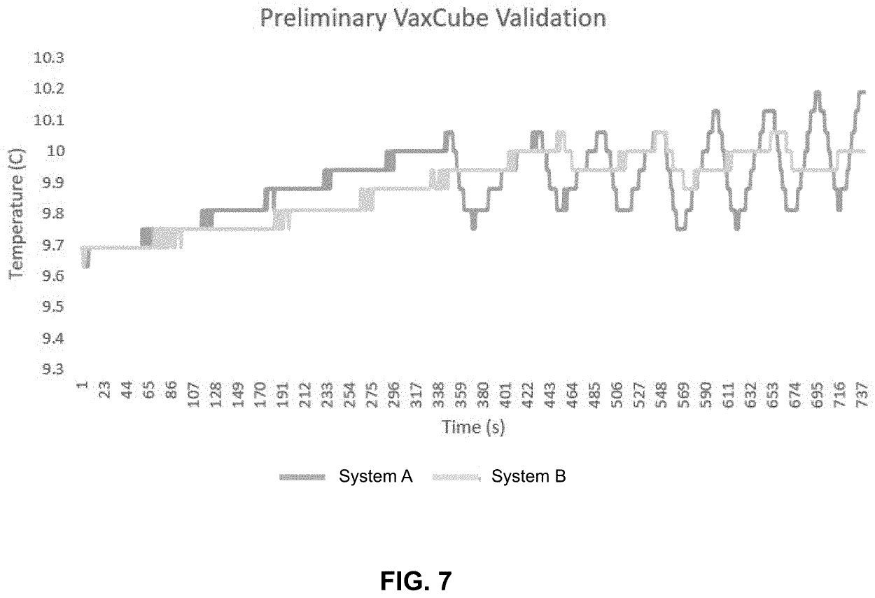

The resulting test block temperatures over time are set forth in FIG. 7. For System A, the temperature of the test block reached 10° C. after about 338 seconds. At that point, the TEC was powered on to reduce the temperature of the test block and the temperature fell below 10° C. at 349 seconds. The temperature continued to drop to around 9.75° C., at which point heat from the heated surface of the TEC transferred back to the cooling surface of the TEC. Because the TEC was fixed to the test block, that heat transfer rapidly raised the temperature thereof to above 10° C. and the TEC had to be activated again to cool it. This cycle continued and as time passed it was more difficult for System A to maintain a stable temperature due to the repeated heating of the TEC's heated surface. Overall, the TEC was powered for 98 seconds over the test period.

System B yielded less erratic temperature changes. The temperature of the test block reached 10° C. at 410 seconds, at which point the cooling system was powered. The TEC was moved between the first and second positions when deactivated and activated, respectively, as described above. As a result, the temperature was maintained within about 0.10° C. of the target temperature after initial activation of the TEC. Overall, the TEC was powered for 32 seconds over the test period, meaning System B consumed 67.3% less power than System A.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A cooler comprising:
a shell that defines a cavity;
a container disposed in the cavity; and
one or more thermoelectric coolers (TECs), each:
having opposing first and second surfaces;
configured to transfer heat from the first surface to the second surface when an electric current flows through the TEC; and
movable between a first position in which the first surface does not contact the container and a second position in which the first surface contacts the container.

2. The cooler of claim 1, wherein:
at least a majority, by weight and/or volume, of the container is a first material; and
at least a majority, by weight and/or volume, of the shell is a second material having a thermal conductivity that is less than or equal to 90% of the thermal conductivity of the first material.

3. The cooler of claim 2, wherein the thermal conductivity of the first material is greater than or equal to 100 W/m·K.

4. The cooler of claim 2, wherein the first material comprises aluminum.

5. The cooler of claim 2, wherein the thermal conductivity of the second material is less than or equal to 0.75 W/m·K.

6. The cooler of claim 1, comprising one or more heat sinks, wherein:
at least a majority, by weight and/or volume, of each of the heat sink(s) is a material having a thermal conductivity that is greater than or equal to 100 W/m·K; and
for each of the TEC(s), the second surface of the TEC is fixed to one of the heat sink(s); and
each of the heat sink(s) is movable relative to the shell.

7. The cooler of claim 6, wherein:
one or more openings are defined through the shell; and
each of the heat sink(s) is disposed in one of the opening(s).

8. The cooler of claim 6, wherein each of the heat sink(s) comprises two or more fins that:
extend in a direction opposite the cavity and toward an exterior of the shell; and
are separated by one or more gaps.

9. The cooler of claim 1, comprising one or more actuators configured to move the TEC(s) between the first and second positions.

10. The cooler of claim 9, wherein:
the one or more TECs comprise two or more TECs; and
at least one of the actuator(s) is configured to move at least two of the TECs.

11. The cooler of claim 9, wherein:
each of the actuator(s) comprises one or more wires, each configured to shrink from a first length to a second length that is smaller than the first length when an electric current flows through the wire; and
the actuator(s) are configured to move the TEC(s) from the first position to the second position when each of the wire(s) shrinks from the first length to the second length.

12. The cooler of claim 9, wherein at least one of the actuator(s) comprises:
a spin plate; and
for each of the TEC(s), a rod coupled to the TEC and slidably disposed in a slot defined by the spin plate, the slot shaped such that when the spin plate rotates in a first direction the rod translates toward the container and the TEC moves from the first position to the second position.

13. The cooler of claim 9, comprising:
one or more temperature sensors, each configured to measure a temperature within the cavity; and
a controller configured to:
receive a temperature measurement from each of the temperature sensor(s); and
actuate the actuator(s) and thereby move each of the TEC(s) between the first and second positions based at least in part on the temperature measurement(s).

14. The cooler of claim 1, wherein the one or more TECs comprise two or more TECs.

15. The cooler of claim 1, comprising a thermally insulating material disposed in the cavity, the thermally insulating material having a thermal conductivity less than or equal to 0.10 W/m·K.

16. The cooler of claim 15, wherein the thermally insulating material is an aerogel.

17. The cooler of claim 1, comprising an electric power source configured to deliver an electric current to each of the TEC(s) and having a capacity that is between 40 and 115 Watt-hours.

18. The cooler of claim 1, wherein the container defines one or more receptacles, each configured to receive one or more vials.

19. The cooler of claim 1, wherein the shell has:
a width and a length, measured perpendicularly to the width, that each is between 4 and 8 inches; and
a height, measured perpendicularly to the width and length, that is between 16 and 32 inches.

20. A cooling system comprising:
one or more thermoelectric cooler (TECs), each:
having opposing first and second surfaces; and
configured to transfer heat from the first surface to the second surface when an electric current flows through the TEC; and
one or more actuators;
wherein the TEC(s) and the actuator(s) are configured to be coupled to a cooler including a shell that defines a cavity and a container disposed in the cavity such that:
each of the TEC(s) is movable between a first position in which the first surface does not contact the container and a second position in which the first surface contacts the container; and
each of the actuator(s) configured to move at least one of the TEC(s) between the first and second positions.
